(19) United States
(12) Patent Application Publication
(10) Pub. No.: US 2002/0110518 A1
(43) Pub. Date: Aug. 15, 2002

(54) Lithium transition metal composite oxide for use as positive active material of lithium secondary battery and method for producing the same

(75) Inventors: Chikaaki Okuda, Aichi (JP); Naoko Takechi, Aichi (JP); Yoshio Ukyo, Aichi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO KENKYUSHO, Aichi-gun (JP)

(21) Appl. No.: 10/003,279

(22) Filed: Dec. 6, 2001

(30) Foreign Application Priority Data
Dec. 8, 2000 (JP) 2000-375071

(51) Int. Cl. C01D 15/02; H01M 4/58

(52) U.S. Cl. 423/594; 423/599; 429/231.1

(57) ABSTRACT

A lithium transition metal composite oxide for use as a positive active material capable of composing a lithium secondary battery of which the internal resistance does not increase greatly even after stored in a charged state for a long period of time, and a method for readily producing such a lithium transition metal composite oxide. The lithium transition metal composite oxide is composed of a transition metal containing at least one selected from the group consisting of Co, Ni and Mn as a main composition element. The composition of a surface layer of each particle of the lithium transition metal composite oxide is made different from that of an inside of each particle. In one example, the ratio of lithium in the composition of the surface layer of each particle is made greater than that in the average composition of each particle. With the method for producing the lithium transition metal composite oxide, specific raw materials are mixed and fired in two stages.

### BACKGROUND OF THE INVENTION

1. Field of the Invention

The present invention relates to a lithium transition metal composite oxide for use as a positive electrode active material, which can compose a lithium secondary battery using dope and undope phenomena of lithium, and a method for producing such a lithium transition metal composite oxide.

2. Description of Related Art

Recently, there is a trend of miniaturing portable telephones, personal computers or the like, and accordingly lithium secondary batteries using dope and undope phenomena of lithium, which are of high energy and high density, have been widely applied in fields of communication equipments and information transmission equipments. On the other hand, in the field of motor vehicles, in consideration of environmental problems and resources problems, the development of electric cars has been expected, and lithium secondary batteries have been investigated as power sources for use in these electric cars.

These lithium secondary batteries of which the development has been demanded in such various fields are, however, expensive so as to be required to have longer lifetime, as compared with other secondary batteries. As one of conditions for extending the lifetime of the lithium secondary batteries, it has been required that, even where lithium secondary batteries had been stored with high charging rates maintained, the internal resistance, for example, thereof does not increase, namely, the lithium secondary batteries exhibit good storage characteristic. In particular, at elevated temperatures, the battery reactions are activated, and the internal resistances are also increased greatly. Consequently, where the lithium secondary batteries are used as electric sources for electric cars which may be left outdoors, good storage characteristic at elevated temperatures is one of important characteristics of the lithium secondary batteries.

Recently, the development of lithium secondary batteries of which positive active materials are composed of lithium transition metal composite oxides, each including transition metals such as Co and Ni as main composition elements, has been proceeded. However, where these lithium secondary batteries are stored with high charging rates maintained, the internal resistances of the batteries greatly increase to cause problems in the storage characteristic thereof, in particular, the storage characteristic at elevated temperatures.

It can be considered that the increase in the internal resistance upon storing the lithium secondary batteries is partly caused by the reaction of the lithium transition metal composite oxide as a positive active material and an electrolyte due to the increase in the positive electrode voltage by charging, which is held for a long period of time.

The present inventors have conducted various experiments, and, as a result, they have found that by making the composition of the surface layer of each particle of the lithium transit metal composite oxide as a positive active material and that of the inside of each particle thereof different from each other, the reaction of the positive active material and the electrolyte can be restrained, and the increase in the internal resistance caused by the storage of the lithium secondary batteries can be restrained.

The present invention has been made based on these findings.

### SUMMARY OF THE INVENTION

It is an object of the present invention to provide lithium transition metal composite oxides for use as positive active materials, capable of composing lithium secondary batteries wherein the reaction of the positive active materials and electrolytes is restrained, and the internal resistance does not increase greatly even after stored in a charged state for a long period of time by making the composition of the surface layer of each particle of the lithium transition metal composite oxides as positive active materials and that of the inside of each particle thereof different from each other.

It is another object of the present invention to provide a method for readily producing the above-described lithium transition metal composite oxides.

One kind of lithium transition metal composite oxide for use as positive active materials of lithium secondary batteries, in accordance with the present invention is the lithium transition metal composite oxide comprising a transition metal as a main composition element, which is composed of at least one selected from the group consisting of Co, Ni and Mn, and is characterized in that the ratio of lithium in a composition of a surface layer of each particle of the lithium transition metal composite oxides is greater than the ratio of lithium in an average composition of each particle thereof.

The other kind of lithium transition metal composite oxide for use as positive active materials of lithium secondary batteries, in accordance with the present invention, is the lithium transition metal composite oxide comprising a transition metal as a main composition element, which is composed of at least one selected from the group consisting Co, Ni and Mn, and is characterized in that at least one substitution element selected from the group consisting of Al and Fe is substituted for one part of the transition metal, and at least one of the following conditions is satisfied: (1) the ratio of lithium in a composition of a surface layer of each particle of the lithium transition metal composite oxide is greater than the ratio of lithium in an average composition of each particle thereof; and (2) the ratio of the at least one substitution element in the composition of the surface layer of each particle of the lithium transition metal composite oxide is less than the ratio of the at least one substitution element in the average composition of each particle thereof.

When the lithium transition metal composite oxide is used as the positive active material, generally, powdered lithium transition metal composite oxide is used. And since the electrolyte contacts surfaces of particles of the powdered lithium transition metal composite oxide, the reaction of the electrolyte and the positive active material can be considered to proceed at a highest rate in these surfaces. The lithium transition metal composite oxide is normally composed of secondary particles resulted from aggregation of fine primary particles. In the present specification, the term “particles” is referred to as these secondary particles unless we refer differently. Namely, the reactivity of the lithium transition metal composite oxide and the electrolyte is considered to be affected by the composition of the surface layer of each particle of the lithium transition metal composite oxide, that is the composition of the surface layer of each secondary particle resulted from coagulation of fine primary particles.

In the above-described two kinds of lithium transition metal composite oxides in accordance with the present invention, the composition of the surface layer of each particle of the lithium transition metal composite oxide is made different from that of the inside of each particle thereof. In one kind of lithium transition metal composite oxide, the ratio of lithium in the composition of the surface layer of each particle is made greater than that in the average composition of each particle.

Excess lithium in the surface layer of each particle is considered to exist in sites other than the normal lithium sites in the crystal structure of the lithium transition metal composite oxide. In the lithium secondary batteries, lithium existing in the normal lithium sites contributes to the charging and discharging thereof so that lithium existing in sites other than the normal lithium sites does not contribute to the charging and discharging thereof. Lithium existing in sites other than the normal lithium sites affects the balance of the electric valence in the lithium transition metal composite oxides. More specifically, in the case of the lithium transition metal composite oxides, each having the basic composition of LiNiO₂, for example, the electric valence of Ni is four in the fully charged state. If there exists excess lithium in the Ni sites, the electric valence of Ni does not become four, but becomes less than four. The state where the electric valence is less than four is similar to the low charged state, that is the low oxidized state, in spite of the fully charged state. Accordingly, it can be considered that when the ratio of lithium in the surface layer of each particle is increased, the oxidation reaction of the surface of each particle of the lithium transition metal composite oxide and the electrolyte is restrained, and even when the lithium secondary battery is stored for a long period of time in a charged state, the increase in the internal resistance thereof is restrained.

It can be also considered to make the lithium ratio in the composition of each particle of the lithium transition metal composite oxide excess in its entirety. In that case, the capacity per active material greatly drops. In accordance with the lithium transition metal composite oxide of the present invention, the composition of the surface layer of each particle is made different from that of the inside of each particle such that the lithium ratio in the composition of the surface layer of each particle, which is adapted to contact the electrolyte, is greater than that in the average composition of each particle. Accordingly, the capacity drop does not occur.

In the other kind of lithium transition metal composite oxide, at least one substitution element selected from the group consisting of Al and Fe is substituted for one part of the transition metal. The present inventors' attention has been directed to not only the ratio of lithium in the composition of the surface layer of each particle of the lithium transition metal composite oxide but also the ratio of the substitution element therein. More specifically, the present lithium transition metal composite oxide is arranged so as to satisfy at least one of the conditions that the ratio of lithium in the composition of the surface layer of each particle of the lithium transition metal composite oxide is greater than the ratio of lithium in the average composition of each particle thereof, and that the ratio of the substitution element in the composition of the surface layer of each particle of the lithium transition metal composite oxide is less than the ratio of the substitution element in the average composition of each particle thereof.

The substitution of at least one substitution element selected from the group consisting of Al and Fe for one part of the transition metal is effective for improving the thermal stability of the lithium transition metal composite oxide. However, in the case where Al, for example, exists in the surface of each particle of the lithium transition metal composite oxide, AlF₃ is formed in the surface of each particle when the lithium secondary battery is stored for a long period of time in a fully charged state, namely a high oxidized state. This AlF₃ is considered to be formed by the reaction of a very small quantity of HF in the electrolyte, and Al existing in the surface of each particle of the lithium transition metal composite oxide. And, since AlF₃ scarcely has lithium ion conductivity and electron conductivity so that, even when a very small quantity of AlF₃ is formed, it acts to increase the internal resistance of the battery. Accordingly, it can be considered that, in the case of the lithium transition metal composite oxide wherein at least one substitution element selected from the group consisting of Al and Fe is substituted for one part of the transition metal, when the composition ratio of the substitution element in the surface layer of each particle is decreased, the reaction of the substitution element and the electrolyte is restrained whereby the increase in the internal resistance of the battery is restrained even when the battery is stored for a long period of time in the charged state. With respect to the ratio of lithium, explanations have been already disclosed. Experimental results show that, when these two conditions are satisfied at the same time, the reaction of the lithium transition metal composite oxide and the electrolyte is further restrained, and the increase in the internal resistance is also restrained.

Since the lithium transition metal composite oxide in accordance with the present invention has such an operation as to be difficult to react with the electrolyte, where the secondary battery is constructed using the lithium transition metal composite oxide in accordance with the present invention as the positive active material, the increase in the internal resistance of a resultant lithium secondary battery is small even when stored for a long period of time in the charged state, whereby the resultant lithium secondary battery exhibits excellent storage characteristic.

The method for producing the lithium transition metal composite oxide in accordance with the present invention is not limited specifically, but the lithium transition metal composite oxide can be readily produced by the following methods. Namely, one method for producing the lithium transition metal composite oxide in accordance with the present invention is characterized in that the method comprises a first mixing step of mixing a lithium compound as a lithium source with a compound composed of at least one selected from the group consisting of Co, Ni and Mn as a transition metal source to obtain a first mixture, a first firing step of firing the first mixture in an oxygen atmosphere to obtain a first lithium transition metal composite oxide, a second mixing step of mixing the first lithium transition metal composite oxide with a lithium compound as a lithium source to obtain a second mixture, and a second firing step of firing the second mixture in an oxygen atmosphere to obtain a second lithium transition metal composite oxide.

The other method for producing the lithium transition metal composite oxide in accordance with the present invention is characterized in that the method comprises a first mixing step of mixing a lithium compound as a lithium source with a compound composed of at least one selected from the group consisting of Co, Ni and Mn as a transition metal source and a compound composed of at least one selected from the group consisting of Al and Fe as a substitution element source to obtain a first mixture, a first firing step of firing the first mixture in an oxygen atmosphere to obtain a first lithium transition metal composite oxide, a second mixing step of mixing the first lithium transition metal composite oxide with a lithium compound as a lithium source and, according to demand, a compound composed of at least one selected from the group consisting of Co, Ni and Mn as a transition metal source to obtain a second mixture, and a second firing step of firing the second mixture in an oxygen atmosphere to obtain a second lithium transition metal composite oxide.

The above-described two methods for producing lithium transition metal composite oxides are methods of mixing and firing specific law materials in two stages, thereby making the composition of the surface layer of each particle of the lithium transition metal composite oxide different from that of the inside of each particle, and accordingly belong to the so-called two-stage firing method. Where lithium compounds are added and fired in two stages, for example, the ratio of lithium in the composition of the surface layer of each particle of the lithium transition metal composite oxide can be made greater than that in the average composition of each particle thereof.

On the other hand, where lithium compounds or the like other than compounds including Al and Fe as the substitution elements are added and fired in two stages, for example, the ratio of substitution elements in the composition of the surface layer of each particle of the lithium transition metal composite oxide can be made less than that in the average composition of each particle thereof.

Accordingly, the methods for producing the lithium transition metal composite oxide in accordance with the present invention are methods facilitating the production of the lithium transition metal composite oxides capable of composing secondary batteries which are difficult to proceed the reaction with the electrolyte, and exhibit very good storage characteristic.

### DETAILED DESCRIPTION OF THE PRESENTLY PREFERRED EXEMPLARY EMBODIMENTS

Hereinafter, the lithium transition metal composite oxides for use as positive active materials of lithium secondary batteries in accordance with the present invention and the methods for producing the same will be respectively explained in order, and then the lithium secondary batteries using the produced lithium transition metal composite oxides will be explained.

<Lithium Transition Metal Composite Oxide>

The lithium transition metal composite oxide in accordance with the present invention comprises a transition metal which is composed of at least one selected from the group consisting of Co, Ni and Mn as a main composition element. It is preferable to use the lithium transition metal composite oxide having the basic composition of LiCoO₂ LiNiO₂ LiMnO₂ or the like, because these basic compositions have high oxidation and reduction voltage so as to compose 4V class lithium secondary batteries. In particular, it is preferable to use lithium nickel composite oxide of which the basic composition is LiNiO₂ including Ni as a main composition element, and which has a regularly arranged layered rock-salt structure, considering that these oxides have great theoretical capacity and are comparatively inexpensive.

The phrase “the basic composition of LiCoO₂ , LiNiO₂, LiMnO₂ or the like” and other like phrases mean that not only the compositions expressed by such chemical formulae but also the compositions obtained by substituting other elements for one part of sites, such as Li, Co, Ni or Mn sites, in the crystal structure thereof, are included. In addition, such phrases mean that not only the stoichiometric compositions but also non-stoichiometric compositions wherein elements are partly lost or become partly excess, are included.

Where the lithium nickel composite oxide having a regularly arranged layered rock-salt structure, of which the basic composition is LiNiO₂, is used, the lithium nickel composite oxide of which the composition is expressed by the composition formula of LiNiₐM′_{b}O₂ (M′ is at least one selected from the group consisting of Co, Mn, Al and Fe; 0.5<a<0.95;0.05<b<0.5) can be adopted. And it is more preferable to adopt the lithium nickel composite oxide of which the composition is expressed by the composition formula of LiNiₓ M1 _{y} M2_{z} O₂ (M1 is at least one selected from the group consisting of Co and Mn; M2 is at least one selected from the group consisting of Al and Fe; 0.5<x<0.95; 0.01<y<0.4; 0.001<z<0.2).

In this LiNiₓM1_{y}M2_{z}O₂, two or more elements of M1 and M2, each serving differently, are substituted for one part of the Ni sites. It is preferable to determine the ratio of remaining Ni unsubstituted, that is the value x in the chemical formula, to 0.5<x<0.95. As compared with the lithium nickel composite oxide wherein the value x of the chemical formula is in the above preferable range, in the case of x≦0.5, not only the layered rock-salt structure but also a second phase having a spinel structure or the like are formed, whereby the capacity drops excessively, and in the case of x≧0.95, the substitution effect is too little so that objective batteries exhibiting good durability cannot be constructed. It is more preferable to determine the range of x to 0.7<x<0.9.

The element M1 selected from the group consisting of Co and Mn mainly acts to stabilize the crystal structure of the lithium nickel composite oxide. With the stabilization of the crystal structure by virtue of the element M1 , the storage characteristic of the secondary battery including a nonaqueous electrolyte is kept good, and in particular, the deterioration of the battery capacity caused by the storage at elevated temperatures is restrained. To achieve the improving effect of the storage characteristic sufficiently, it is preferable to determine the substitution ratio of M1, that is the value y in the composition formula, to 0.01<y<0.4. As compared with the case within this preferred range of y, in the case of y≦0.01, the stabilization of the crystal structure of a resultant secondary battery is insufficient so that the durability is not good, and in the case of y≧0.4, the crystallinity of the lithium nickel composite oxide drops, which is less preferable. It is more preferable to determine the value y to 0.05<y<0.3. Furthermore, Co acts to restrain the capacity drop caused by the substitution of elements, and has an advantage of restraining the crystallinity drop to a minimum, because Li(Co, Ni) O₂ is of a totally solid-dissolved type. Considering these characteristics, it is more desirable to use Co as M1.

The element M2 selected from the group consisting of Al and Fe mainly acts to restrain the decomposition of active materials, which is caused by the release of oxygen, and accordingly to improve the thermal stability. To achieve these functions, it is preferable to determine the substitution ratio of M2, that is the value z in the composition formula, to 0.01<z<0.2. As compared with the case of this preferred range of z, in the case of z≦0.001, the safety becomes insufficient, and in the case of z≧0.2, the capacity of the positive electrode drops, which is less preferable. It is more preferable to determine the value z to 0.004<z<0.1. Furthermore, Al acts to restrain the capacity drop to a minimum while improving the thermal stability. Considering these characteristics, it is more desirable to use Al as M2.

Furthermore, in the lithium transition metal composite oxides in accordance with the present invention, the ratio of lithium in the composition of the surface layer of each particle thereof is greater than that in the average composition of each particle. Where at least one substitution element of Al and Fe is substituted for one part of the transition metal included, the lithium transition metal composite oxides satisfy at least one of conditions that the ratio of lithium in the composition of the surface layer of each particle is greater than that in the average composition of each particle, and that the ratio of substitution elements in the composition of the surface layer of each particle is less than that in the average composition of each particle.

In the present disclosure, the composition of the surface layer of each particle means the composition of an outer peripheral part of each particle of a powdered lithium transition metal composite oxide. In the present specification, values measured by the analysis with an x-ray electron spectroscopic method (XPS) are adopted. With the above-described analysis, the composition of the surface layer of each particle corresponds to the average composition in an outer peripheral part having a thickness of about 3 nm from the surface of each particle. The average composition of each particle means the composition of composition elements, which is obtained by averaging the compositions in the entire particle without distinguishing the surface layer of each particle from the inside thereof. In the lithium transition metal composite oxide in accordance with the present invention, the composition in the surface layer of each particle is different from that in the inside thereof, but gradually changes thereto.

Where the lithium transition metal composite oxide is expressed by the composition formula of LiMa₁₋ₚMbₚO₂ (Ma is at least one selected from the group consisting of Ni, Co and Mn, Mb is at least one selected from the group consisting of Al and Fe), for example, the average composition of each particle includes Li, Ma, Mb and O in the mole ratio of 1:1-p:p:2. Accordingly, the composition of the surface layer of each particle satisfies at least one of two conditions: (1) the ratio of Li is greater than 1; and (2) the ratio of Mb is less than p.

In order to further enhance the effect of restraining the reaction with the electrolyte, and consequently restraining the increase in the internal resistance, it is preferable that the ratio of lithium in the surface layer of each particle is 1.2 or more times that in the average composition of each particle. In addition, in order to further enhance the effect of restraining the reaction with the electrolyte, and consequently restraining the increase in the internal resistance, it is preferable that the ratio of the substitution element in the surface layer of each particle is 0.8 or less times the ratio of the substitution element in the average composition of each particle.

<Method for Producing Lithium Transition Metal Composite Oxide>

The method for producing the lithium transition metal composite oxide in accordance with the present invention is not limited specifically, but the lithium transition metal composite oxide in accordance with the present invention can be readily produced with the producing method in accordance with the present invention. Namely, the producing method in accordance with the present invention comprises a first mixing and firing step of mixing specific law materials together and firing a resultant mixture, and a second mixing and firing step of adding and mixing specific law materials, and firing a resultant mixture. These steps will be explained.

(1) First Mixing Step

This step is the step of mixing a lithium compound as a lithium source and a compound containing at least one selected from the group consisting of Co, Ni and Mn as a transition metal source with each other to obtain a first mixture.

Examples of the lithium compound as the lithium source include lithium hydroxide, lithium carbonate and lithium nitrate. In particular, it is preferable to use lithium hydroxide, because the melting point is about 450° C. which is comparatively low.

Examples of the compound as the transition metal source include hydroxides such as cobalt hydroxide and nickel hydroxide, carbonates such as cobalt carbonate and nickel carbonate, nitrates such as cobalt nitrate and nickel nitrate, and oxides such as manganese dioxide and manganese sesquioxide. In particular, where Co and Ni are used as main composition elements, considering the battery service life when constructed, it is preferable to use cobalt hydroxide and nickel hydroxide, because these hydroxides exhibit high reactivity.

To produce the lithium transition metal composite oxide wherein at least one substitution element selected from the group consisting of Al and Fe is substituted for one part of the transition metals included, in this step, compounds including the above-described substitution element are further mixed. Examples of the compound including the substitution element includes aluminum hydroxide, aluminum nitrate and iron nitrate. In particular, where Al is used as the substitution element in view of the reactivity, it is preferable to use aluminum hydroxide, because no gas is generated while being fired.

The above-described raw materials may be in the form of powder, and may be mixed by the method which has been used to mix normal powders. More specifically, these raw materials may be mixed, using ball mills, mixers, mortars or the like. And the mixing ratio of these raw materials may be the ratio corresponding to the composition of the lithium transition metal composite oxide to be produced. Since the lithium compound and the compound including the substitution metal are further added in the second mixing step, in the first mixing step, the mixing amount of these compounds must be determined, considering the amount to be added in the second mixing step.

(2) First Firing Step

This step is the step of firing a mixture obtained in the first mixing step in an oxygen atmosphere to obtain a first lithium transition metal composite oxide. The preferred firing temperature ranges from 450° C. to 1000° C. Where the firing temperature is lower than 450° C., the reaction does not proceed sufficiently, and accordingly the crystallinity becomes low. In contrast, where the firing temperature exceeds 1000° C., lithium becomes gaseous, and consequently, lithium does not contribute to the reaction greatly. The firing time may be the time enough to complete firing of the first mixture, and may be normally about 12 hours.

(3) Second Mixing Step

This step is the step of mixing the first lithium transition metal composite oxide obtained in the first firing step with the lithium compound as the lithium source, and if required, the compound containing at least one selected from the group consisting of Co, Ni and Mn as the transition metal source with each other to obtain a second mixture.

The above-described compounds may be used as the lithium compound and the transition metal source compound. Lithium compound identical to that used in the first mixing step may be used as the lithium compound of the lithium source. Otherwise, different lithium compounds may be used. The compound identical to that used in the first mixing step may be used as the compound of the transition metal source. Where the elements included in that compound are identical to those included in the compound used in the first mixing step, different compounds from the compound used in the first mixing step may be used.

The first lithium transition metal composite oxide and the above-described raw materials may be mixed with each other by the method which has been used to mix normal powders, similarly to the first mixing step. In addition, the amount of the above-described raw materials to be mixed may be determined, considering the amount added in the first mixing step.

(4) Second Firing Step

This step is the step of firing the second mixture obtained in the second mixing step in an oxygen atmosphere. The preferred firing temperature ranges from 450° C. to 700° C. When the firing temperature is lower than 450° C., sufficient firing cannot be performed. On the contrary, when the firing temperature exceeds 700° C., it is considered that lithium and the like added in the second mixing step become easy to disperse into the inside of each particle, and as a result, the composition of each particle is easy to become homogeneous in the above-described firing temperature range. The more preferred firing temperature is 650° C. or less for enlarging the difference between the composition in the surface layer of each particle and that in the inside of each particle. The firing time may be the time enough to complete re-firing of the second mixture, and may be normally about 1 hour.

<Lithium Secondary Battery>

By using the lithium transition metal composite oxide in accordance with the present invention as the positive active material, lithium secondary batteries can be constructed. Hereinafter, the main construction of the lithium secondary battery will be explained. The lithium secondary battery is generally composed of a positive electrode and a negative electrode for dope and undope lithium ions, a separator interposed between the positive electrode and negative electrode, and a nonaqueous electrolyte for moving the lithium ions between the positive electrode and the negative electrode. The secondary battery of the present embodiment also has this construction. Hereinafter, these components will be explained.

The positive electrode can be formed by mixing a conductive material and a binder with a positive active material capable of dope and undope lithium ions, adding a proper solvent to a resultant mixture to form a paste-like positive electrode material, applying the formed paste-like positive electrode material to a surface of a current collector made of metallic foil such as aluminum foil, and after drying, pressing a resultant film to increase the density of the active material.

In the present embodiment, the lithium transition metal composite oxide in accordance with the present invention is used as the positive active material. One kind of lithium transition metal composite oxide or a mixture of two or more kinds thereof can be used as the positive active material.

The conductive material to be used as the positive electrode acts to ensure the electroconductive properties of the positive active material layer, and one kind or a mixture of two or more kinds of powdered carbon materials such as carbon black, acetylene black or graphite can be used as the conductive material. The binder acts to connect particles of the active materials. Fluorine-containing resins such as polytetrafluoroethylene, polyvinylidene fluoride and fluoro rubber, and thermoplastic resins such as polypropylene and polyethylene can be used. Organic solvents such as N-methyl-2-pyrrolidone can be used as the solvent for dispersing these active materials, conductive materials and binders.

The negative electrode can be produced by forming metal lithium as the negative electrode active material into a sheet-like configuration, similarly to the case of normal batteries, or pressure-bonding a sheet-like metal lithium to a current collector net made of nickel, stainless steel or the like. Instead of metal lithium, lithium alloys or lithium compounds can be used as the negative active material.

In another example of the negative electrode, carbon materials capable of dope and undope lithium ions can be used as the negative active material. Examples of the carbon material include natural or artificial graphite, fired bodies of organic compounds such as phenol resins, and powdered bodies of coke or the like. In this case, the negative electrode can be produced by mixing a binder to the negative active material, adding a proper solvent to a resultant mixture to obtain a paste-like negative electrode material, applying the paste-like negative electrode material to a surface of a current collector composed of metallic foil such as copper foil, and drying the applied negative electrode material.

Where the carbon material is used as the negative active material, fluorine-containing resins such as polyvinylidene fluoride can be used as the binder, and organic solvents such as N-methyl-2-pyrrolidone can be used as the solvents, similarly to the case of the positive electrode.

A separator to be interposed between the positive electrode and negative electrode acts to separate the positive electrode and negative electrode from each other and retain the electrolyte, thereby passing ions. Micro-porous films composed of polyethylene, polypropylene or the like can be used.

The nonaqueous electrolyte is prepared by dissolving an electrolyte in an organic solvent. Examples of the organic solvent include a non-proton organic solvent such as ethylene carbonate, propylene carbonate, dimethyl carbonate, diethyl carbonate, γ-butyrolactone, acetonitrile, dimethoxy ethane, tetrahydrofuran, dioxolane, methylene chloride or the like. A mixture liquid of one or more of these materials can be used. And examples of the electrolyte to be dissolved include LiI, LiClO₄ LiAsF₆ , LiBF₄ and LiPF₆, each of which generates lithium ion by being dissolved.

In place of the arrangement of the separator and the nonaqueous electrolyte, a high polymer solid electrolyte which is obtained by using polymer having a high molecular weight, such as polyethylene oxide, and lithium salts such as LiClO₄ and LiN(CF₃SO₂)₂ , can be used. In addition, gel-like electrolyte which is obtained by trapping the above-described nonaqueous electrolyte in a solid high polymer matrix such as polyacrylonitrile, can be used.

The lithium secondary battery according to this embodying form can be the coin type, laminate type, cylindrical type, etc. In any types, the separator is sandwiched between the positive electrode and the negative electrode as the electrode unit, for conducting the portions between the positive electrode and the positive terminal, and the portion between the negative electrode and the negative terminal, respectively. This electrode unit is packed into the battery case together with the nonaqueous electrolytic solution to construct the battery.

<Permission of other Embodiments>

The above-described embodiment of the lithium transition metal composite oxide, the method for producing the same, and the lithium secondary battery are merely examples of embodiments of the present invention, and the lithium transition metal composite oxide in accordance with the present invention, the method for producing the same, and the lithium secondary battery using the lithium transition metal composite oxide as the positive active material are not limited to the disclosed embodiments, but, on the contrary, can be embodied in arrangements wherein various modifications and improvements are applied based on knowledge of those skilled in the art.

### EXAMPLES

Various kinds of lithium transition metal composite oxides having different compositions in the surface layer of each particle were produced based on the above-described embodiment. In addition, lithium transition metal composite oxides were produced with a conventional method. Then, lithium secondary batteries using these lithium transition metal composite oxides as positive active materials were produced, and the storage characteristics thereof were evaluated.

Hereinafter, lithium transition metal composite oxide and the evaluation of the storage characteristic of each lithium secondary battery will be explained.

<Lithium Transition Metal Composite Oxide>

(1) First Series of Lithium Transition Metal Composite Oxide

Lithium nickel composite oxide with a regularly arranged layered rock-salt structure, of which each particle has an average composition expressed by the composition formula LiNi_{0.8}Co0.₂O₂ was produced. First, LiOH.H₂O as a lithium source and Ni(OH)₂ and CO(OH)₂ as transition metals source were mixed together such that Li, Ni and Co were included in the mole ratio of 0.95:0.8:0.2. A resultant mixture was fired in an oxygen gas at 900° C. for 12 hours to obtain a first lithium nickel composite oxide. Then, the obtained first lithium nickel composite oxide was pulverized into powder.

0.05 mole of LiOH.H₂O was further added to and mixed with powder-like first lithium nickel composite oxide, and re-fired in an oxygen gas for 1 hour at temperatures of 600° C., 650° C., 700° C., and 750° C. respectively to obtain various second lithium nickel composite oxides. Next, these second lithium nickel composite oxides were pulverized into powders of lithium nickel composite oxides. These powders were numbered as the first series of lithium transition metal composite oxides from #1-1 to #1-4 in the order of increasing re-firing temperature.

The average composition of each of the above-described lithium transition metal composite oxides of #1-1˜4 was analyzed with the composition analysis. As a result, it has been confirmed that these lithium transition metal composite oxides are all lithium nickel composite oxides expressed by the composition formula of LiNi_{0.8}Co_{0.2}O₂. The composition ratio of Li, Ni and Co in the surface layer of each particle was analyzed by the X-ray electron spectroscopic method (XPS). The analysis result is shown in TABLE 1. The analysing device used was PHI-5500MC which was manufactured at ULVAC-PHI, Inc. MgK α ray was used as an X-ray source, and the analysis range was about ø 800 μm (in the succeeding XPS analyses, these conditions will be applied). In Table 1, the ratios of Li and Co where the ratio of Ni is fixed to 0.8 are shown (In Tables 2 to 4, the ratios of Li, Ni and Co are determined, similarly).

TABLE 1

| Sample | Re-firing | | | |
|---|---|---|---|---|
| No. | temperature/° C. | Li | Ni | Co |
| #1-1 | 600 | 1.41 | 0.8 | 0.19 |
| #1-2 | 650 | 1.23 | 0.8 | 0.2 |
| #1-3 | 700 | 1.12 | 0.8 | 0.19 |
| #1-4 | 750 | 1.01 | 0.8 | 0.2 |

※ Average composition LiNi 0.8 Co 0.2 O 2

As shown in Table 1, the ratio of Li in the surface layer of each particle of the first series of lithium transition metal composite oxides, which depended on the re-firing temperature, was greater than 1 which was the ratio of Li in the average composition. In particular, the ratio of Li at the re-firing temperature of 650° C. or less was 1.2 or more times the ratio of Li in the average composition. When the re-firing temperature was elevated to about 750° C., the composition of the surface layer of each particle became approximately equal to the average composition. This result can be considered to be caused by the dispersing of Li into the inside of each particle proceeding. Accordingly, the lithium transition metal composite oxides of #1-1˜3 are the lithium transition metal composite oxides in accordance with the present invention.

(2) Second Series of Lithium Transition Metal Composite Oxide

Lithium nickel composite oxide with a regularly arranged layered rock-salt structure, of which each particle had an average composition expressed by the composition formula of LiNi_{0.8}Co_{0.15}Al_{0.05}O₂, was produced. First, LiOH.H₂O as a lithium source, Ni(OH)₂ and CO(OH)₂ as a transition metal source, and Al (OH)₃ as a substitution element source were mixed together such that Li, Ni, Co and Al were included in the mole ratio of 0.95:0.76:0.1425:0.05. A resultant mixture was fired in an oxygen gas at 900° C. for 12 hours to obtain a first lithium nickel composite oxide. Then, the obtained first lithium nickel composite oxide was pulverized into powder.

LiOH.H₂O, Ni(OH)₂ and Co(OH)₂ were further added to and mixed with the powder-like first lithium nickel composite oxide such that Li, Ni and Co were included in the mole ratio of 0.05:0.04:0.0075. Resultant mixtures were respectively re-fired in an oxygen gas for 1 hour at temperatures of 600° C., 650° C., 700° C. and 750° C. to obtain various kinds of second lithium nickel composite oxides. Next, these second lithium nickel composite oxides were pulverized into powders of lithium nickel composite oxides. These powders were numbered as the second series of lithium transition metal composite oxides from #2-5 to #2-8 in the order of increasing re-firing temperature.

The average composition of each of the above-described lithium transition metal composite oxides of #2-5˜8 was analyzed with the composition analysis. As a result, it has been confirmed that these lithium transition metal composite oxides are all lithium nickel composite oxides expressed by the composition formula of LiNi_{0.05}Co_{0.15}Al_{0.05}O₂. The composition ratio of Li, Ni and Co in the surface layer of each particle was analyzed by the X-ray electron spectroscopic method (XPS). The analysis result is shown in TABLE 2.

TABLE 2

| | Re-firing | | | | |
|---|---|---|---|---|---|
| Sample | temperature/ | | | | |
| No. | ° C. | Li | Ni | Co | Al |
| #2-5 | 600 | 1.01 | 0.8 | 0.14 | 0.01 |
| #2-6 | 650 | 1.02 | 0.8 | 0.14 | 0.03 |
| #2-7 | 700 | 1.02 | 0.8 | 0.15 | 0.05 |
| #2-8 | 750 | 1.01 | 0.8 | 0.15 | 0.05 |

※Average composition LiNi_{0.8}Co_{0.15}Al_{0.05}O₂

As shown in Table 2, the ratio of Li in the surface layer of each particle of the second series of lithium transition metal composite oxides was not so increased, as compared with that of the average composition. On the other hand, the ratio of Al, which depended on the re-firing temperature, was less than 0.05 which was the ratio of Al in the average composition. In particular, the ratio of Al at the re-firing temperature of 650° C. or less was 0.6 or less times the ratio of Al in the average composition. When the re-firing temperature was elevated to about 700° C., the composition of the surface layer of each particle became approximately equal to the average composition. As described above, this result can be considered to be caused by the dispersing of elements such as Li into the inside of each particle proceeding due to high re-firing temperature. Accordingly, the lithium transition metal composite oxides of #2-5,6 are the lithium transition metal composite oxides in accordance with the present invention.

(3) Third Series of Lithium Transition Metal Composite Oxide

Lithium nickel composite oxide with a regularly arranged layered rock-salt structure, of which each particle had an average composition expressed by the composition formula of LiNi_{0.8}Co_{0.15}Al_{0.05}O₂, was produced, similarly to the second series of lithium transition metal composite oxides except that the ratio of LiOH.H₂O to be added first was changed from 0.95 to 0.9, and the ratio of LiOH.H₂O to be added later was changed from 0.05 to 0.1. Obtained powders of the lithium nickel composite oxide were numbered as the third series of lithium transition metal composite oxides from #3-9 to #3-12 in the order of increasing re-firing temperature.

The average composition of each particle of the above-described lithium transition metal composite oxides of #3-9˜12 was confirmed by the composition analysis. As a result, it has been confirmed that these lithium transition metal composite oxides are all lithium nickel composite oxides expressed by the composition formula of LiNi_{0.8}Co_{0.15}Al_{0.05}O₂. The composition ratio of Li, Ni and Co in the surface layer of each particle was analyzed by the X-ray electron spectroscopic method (XPS). The analysis result is shown in TABLE 3.

TABLE 3

| | Re-firing | | | | |
|---|---|---|---|---|---|
| Sample | temperature/ | | | | |
| No. | ° C. | Li | Ni | Co | Al |
| #3-9 | 600 | 1.38 | 0.8 | 0.14 | 0.01 |
| #3-10 | 650 | 1.25 | 0.8 | 0.15 | 0.03 |
| #3-11 | 700 | 1.12 | 0.8 | 0.14 | 0.04 |
| #3-12 | 750 | 1.03 | 0.8 | 0.15 | 0.05 |

※Average composition LiNi_{0.8}Co_{0.15}Al_{0.05}O₂

As shown in Table 3, the ratio of Li in the surface layer of each particle of the third series of lithium transition metal composite oxides, which depended on the re-firing temperature, was greater than 1 which was the ratio of Li in the average composition. In particular, the ratio of Li at the re-firing temperature of 650° C. or less was 1.2 or more times the ratio of Li in the average composition. The ratio of Al, which also depended on the re-firing temperature, was less than 0.05 which was the ratio of Al in the average composition. In particular, the ratio of Al at the re-firing temperature of 700° C. or less was 0.8 or less times the ratio of Al in the average composition. When the re-firing temperature was elevated to about 750° C., the composition of the surface layer of each particle became approximately equal to the average composition. Accordingly, the lithium transition metal composite oxides of #3-9˜11 are the lithium transition metal composite oxides in accordance with the present invention.

(4) Fourth Series of Lithium Transition Metal Composite Oxide

Two kinds of Lithium nickel composite oxides, each having a regularly arranged layered rock-salt structure, which were respectively expressed by the composition formula of LiNi_{0.8}Co_{0.2}O₂ and LiNi_{0.8}Co_{0.15}Al_{0.05}O₂, were produced with a conventional method.

(A) Production of the Lithium Nickel Composite Oxide Expressed by the Composition Formula of LiNi_{0.8}Co_{0.2}O₂

LiOH.H₂O as a lithium source, and Ni(OH)₂ and Co(OH)₂ as a transition metal source were mixed together such that Li, Ni and Co were included in the mole ratio of 1:0.8:0.2. A resultant mixture was fired in an oxygen gas at 900° C. for 12 hours to obtain lithium nickel composite oxide. Then, the obtained lithium nickel composite oxide was pulverized into powder to obtain a fourth series of lithium transition metal composite oxide (Sample No. #4-13).

(B) Production of the Lithium Nickel Composite Oxide Expressed by the Composition Formula of LiNi_{0.8}Co_{0.15}Al_{0.05}O₂

LiOH.H₂O as a lithium source, Ni(OH)₂ and Co(OH)₂ as a transition metal source, and Al(OH)₃ as a substitution element source were mixed together such that Li, Ni, Co and Al were included in the mole ratio of 1:0.8:0.15:0.05. A resultant mixture was fired in an oxygen gas at 900° C. for 12 hours to obtain lithium nickel composite oxide. Then, the obtained lithium nickel composite oxide was pulverized into powder to obtain fourth series of lithium transition metal composite oxide (Sample No. #4-14).

The average composition of each particle of the above-described lithium transition metal composite oxides of #4-13, 14 was confirmed by the composition analysis. As a result, it has been confirmed that these lithium transition metal composite oxides are lithium nickel composite oxides expressed by the composition formulae of LiNi0.8Co0.2O2 and LiNi0.8Co0.15Al0.05O2, respectively. The composition ratio of Li, Ni and Co in the surface layer of each particle was analyzed by the X-ray electron spectroscopic method (XPS). The analysis result is shown in TABLE 4.

TABLE 4

| | firing | | | | |
|---|---|---|---|---|---|
| Sample | temperature/ | | | | |
| No. | ° C. | Li | Ni | Co | Al |
| #4-13 | 900 | 1.02 | 0.8 | 0.19 | — |
| #4-14 | 900 | 1.01 | 0.8 | 0.14 | 0.05 |

※Average composition
13: LiNi_{0.8}Co_{0.2}O₂
14: LiNi_{0.8}Co_{0.15}Al_{0.05}O₂

As shown in Table 4, the ratios of Li and Al in the surface layer of each particle of the fourth series of lithium transition metal composite oxides were approximately equal to those in the average composition. It has been confirmed that each particle of the fourth series of lithium transition metal composite oxides has a homogeneous composition.

<Evaluation of the Storage Characteristic of the Lithium Secondary Battery>

(1) Production of Lithium Secondary Batteries

Lithium secondary batteries were produced, using the first to fourth series of lithium transition metal composite oxides as the positive active materials. First, a paste-like positive electrode material was prepared by mixing 85 parts by weight of each of the above-described lithium nickel composite oxides as a positive active material, 10 parts by weight of carbon black as a conductive material and 5 parts by weight of polyvinylidene fluoride as a binder together, and adding a proper amount of N-methyl-2-pyrrolidone as a solvent. Next, the paste-like positive electrode material was applied to both sides of an aluminum foil current collector having a thickness of 20 μm, dried and then compressed by means of a roll press to form a sheet-like positive electrode in which the positive electrode material has a thickness of 40 μm, on each side of the aluminum foil current collector. Upon using, the sheet-like positive electrode was cut to have dimensions of 54 mm×450 mm.

Artificial graphite was used as an active material of a negative electrode for facing the positive electrode. First, a paste-like negative electrode material was prepared by mixing 95 parts by weight of artificial graphite as the negative active material with 5 parts by weight of polyvinylidene fluoride as a binder, and adding a proper amount of N-methyl-2-pyrrolidone as a solvent. Next, the paste-like negative electrode material was applied to both sides of a copper foil current collector having a thickness of 10 μm, dried, and then compressed by means of a roll press to obtain a sheet-like negative electrode, in which negative electrode material has a thickness of 30 μm, on each side of the copper foil current collector. Upon using, the sheet-like negative electrode was cut to have dimensions of 56 mm×500 mm.

The thus prepared positive electrode and negative electrode were wound with a separator composed of polyethylene, and having a thickness of 25 μm and a width of 58 mm interposed therebetween, thereby obtaining a roll-like electrode body. Next, the roll-like electrode body was inserted in a cylindrical battery casing of 18650 type (outside diameter: 18 mm ø, length: 65 mm), a nonaqueous electrolyte was poured therein, and the cylindrical battery casing was sealed to obtain a cylindrical lithium secondary battery. The nonaqueous electrolyte was prepared by dissolving LiPF₆ in a mixture solvent obtained by mixing ethylene carbonate and diethyl carbonate in the volume ratio of 1:1, with a concentration of 1 M.

First series of lithium secondary batteries use the first series of lithium transition metal composite oxides (#1-1˜4) as the positive active materials thereof, second series of lithium secondary batteries use the second series of lithium transition metal composite oxides (#2-5 ˜8) as the positive active materials thereof, third series of lithium secondary batteries use the third series of lithium transition metal composite oxides (#3-9˜12) as the positive active materials thereof, and fourth series of lithium secondary batteries use the fourth series of lithium transition metal composite oxides (#4-13˜14) as the positive active materials thereof.

<Evaluation of the Storage Characteristic>

The storage characteristic of each of the first to fourth series of lithium secondary batteries was evaluated. First, for conditioning, each lithium secondary battery was charged up to 4.1 V with a constant current having a current density of 0.2 mA/cm₂ at 20° C., and then discharged with a constant current having a current density of 0.2 mA/cm₂ until the voltage decreased to 3.0 V. After conditioning, for measuring the initial capacity, each lithium secondary battery was subjected to three cycles of charging and discharging at 20° C. In each cycle of charging and discharging, each battery was charged with a constant current having a current density of 0.1 mA/cm₂ until the voltage increased to the charging upper limit voltage of 4.1 V, was continuously charged with a constant voltage of 4.1 V for 2 hours, and then was discharged with a constant current having a current density of 0.1 mA/cm₂ until the voltage decreased to the discharging lower limit voltage of 3.0 V. The initial capacity at 20° C. was determined from the discharge capacity at the third charging and discharging cycle.

Next, to calculate the initial internal resistance, the input power and output power were measured, and the internal resistances at the input time and output time were calculated. The input and output powers were measured under the following conditions. First, each lithium secondary battery charged up to 50% of the initial capacity (SOC 50%) was discharged with a current of 1A for 10 seconds, and the voltage was measured. And, each lithium secondary battery was charged again to the state of SOC 50% and discharged with a current of 3A for 10 seconds, and the voltage was measured. And, each lithium secondary battery was charged to the state of SOC 50%, and discharged with a current of 5A for 10 seconds. Then, the voltage was measured. And the dependence of voltage on current was obtained, and an incline of the current-voltage line was regarded as the internal resistance at the output time. Next, each lithium secondary battery was charged, similarly, the voltage after ten seconds was measured to obtain the internal resistance at the input time form the incline of the current-voltage line. The average value of the internal resistances at the input time and output time was regarded as the initial internal resistance.

Then, the storage test was performed. Each lithium secondary battery was charged with a constant current having a current density of 0.2 MA/cm₂ until the voltage reached 4.1 V, and continuously charged with a constant voltage of 4.1 V. By charging for 7 hours, totally, each secondary battery was brought into the state of SOC 100%, and then stored within a constant temperature tank of 60° C. for 1 month. After storing, the residual capacity and the recovery capacity were measured, and the internal resistances at the input time and the output time were obtained, similarly to the above-described case, and by averaging these internal resistances, the internal resistance after storage was obtained.

In this case, the residual capacity is the capacity obtained when each secondary battery after the storage test was discharged at the temperature of 20° C. And each secondary battery after the measurement of the residual capacity was subjected to 3 cycles of charging and discharging at the temperature of 20° C., and the discharge capacity at the third cycle of charging and discharging was regarded as the recovery capacity. In each cycle of charging and discharging, each battery was charged with a constant current having a current density of 0.1 mA/cm₂ until the voltage increased to the charging upper limit voltage of 4.1 V, was continuously charged with a constant voltage of 4.1 V for 2 hours, and then was discharged with a constant current having a current density of 0.1 MA/cm₂ until the voltage decreased to the discharging lower limit voltage of 3.0 V.

Then, the capacity residual rate was obtained using the formula [residual capacity/initial capacity×100], and the capacity recovery rate was obtained using the formula [recovery capacity/initial capacity×100]. In addition, the internal resistance increase rate was calculated from the internal resistances before and after the storage test, using the formula [(internal resistance after storage/initial internal resistance)-1}×100]. The initial capacity, capacity residual rate, capacity recovery rate, initial internal resistance and internal resistance increase rate of each of the first to fourth series of secondary batteries are shown in TABLES 5 to 8.

TABLE 5

| | | | | Initial | Internal |
|---|---|---|---|---|---|
| | Initial | Capacity | Capacity | internal | resistance |
| Sample | capacity | residual | recovery | resistance | increase |
| No. | (mAh/g) | rate (%) | rate (%) | (mΩ) | rate (%) |
| #1-1 | 162 | 88 | 97 | 77 | 25 |
| #1-2 | 163 | 87 | 98 | 77 | 21 |
| #1-3 | 163 | 88 | 97 | 75 | 55 |
| #1-4 | 162 | 86 | 98 | 76 | 60 |

TABLE 6

| | | | | Initial | Internal |
|---|---|---|---|---|---|
| | Initial | Capacity | Capacity | internal | resistance |
| Sample | capacity | residual | recovery | resistance | increase |
| No. | (mAh/g) | rate (%) | rate (%) | (mΩ) | rate (%) |
| #2-5 | 158 | 87 | 98 | 78 | 32 |
| #2-6 | 157 | 88 | 98 | 76 | 29 |
| #2-7 | 159 | 87 | 99 | 75 | 55 |
| #2-8 | 158 | 87 | 99 | 78 | 55 |

TABLE 7

| | | | | Initial | Internal |
|---|---|---|---|---|---|
| | Initial | Capacity | Capacity | internal | resistance |
| Sample | capacity | residual | recovery | resistance | increase |
| No. | (mAh/g) | rate (%) | rate (%) | (mΩ) | rate (%) |
| #3-9 | 157 | 88 | 98 | 76 | 21 |
| #3-10 | 159 | 87 | 98 | 75 | 14 |
| #3-11 | 157 | 87 | 98 | 77 | 41 |
| #3-12 | 158 | 86 | 99 | 76 | 55 |

TABLE 8

| | | | | Initial | Internal |
|---|---|---|---|---|---|
| | Initial | Capacity | Capacity | internal | resistance |
| Sample | capacity | residual | recovery | resistance | increase |
| No. | (mAh/g) | rate (%) | rate (%) | (mΩ) | rate (%) |
| #4-13 | 163 | 87 | 97 | 77 | 62 |
| #4-14 | 158 | 88 | 98 | 78 | 56 |

As is apparent from Tables 5 to 8, there is not recognized a great difference in the initial capacity, capacity residual rate, capacity recovery rate, and initial internal resistance between the first to fourth series of secondary batteries. However, these tables show that the values of the initial resistance increase rate are greatly different from each other, depending on the composition of the surface layer of each particle of the lithium transition metal composite oxide used as the positive active material.

As shown in Table 8, in the fourth series of secondary batteries using the lithium transition metal composite oxide of which particle has a homogeneous composition in its entirety, the internal resistance increase rate is as high as 56% and 62%. On the other hand, in the first series of secondary batteries shown in Table 5, as the ratio of Li in the composition of the surface layer of each particle increases, as compared with the ratio of Li in the average composition thereof, the internal resistance increase rate decreases. In particular, the internal resistance increase rates of the secondary batteries which use the lithium transition metal composite oxides (#1-1, 2) wherein the ratio of Li in the composition of the surface layer of each particle is respectively 1.2 or more times the ratio of Li in the average composition, as the positive active materials, are about one third of the internal resistance increase rates of the secondary batteries which use the lithium transition metal composite oxides (#1-4, #4-13) wherein each particle has a homogeneous composition in its entirety.

In the second series of secondary batteries shown in Table 6, as the ratio of Al in the composition of the surface layer of each particle decreases, as compared with the ratio of Al in the average composition, the internal resistance increase rate decreases. In particular, the internal resistance increase rates of the secondary batteries which use the lithium transition metal composite oxides (#2-5, 6) wherein the ratio of Al in the composition of the surface layer of each particle is respectively 0.6 or less times the ratio of Al in the average composition, as the positive active materials thereof, are about one half of the internal resistance increase rates of the secondary batteries which use the lithium transition metal composite oxides (#2-7,8, #4-14) wherein each particle has a homogeneous composition in its entirety.

Furthermore, in the third series of secondary batteries shown in Table 7, as the ratio of Li in the composition of the surface layer of each particle increases, as compared with the ratio of Li in the average composition, and the ratio of Al in the composition of the surface layer of each particle decreases, as compared with the ratio of Al in the average composition, the internal resistance increase rate decreases. In particular, the internal resistance increase rates of the secondary batteries which use the lithium transition metal composite oxides (#3-9, 10) wherein the ratio of Li in the composition of the surface layer of each particle is respectively 1.2 or more times the ratio of Li in the average composition, and the ratio of Al in the composition of the surface layer of each particle is respectively 0.6 or less times the ratio of Al in the average composition, as the positive active materials, are about one third to one fourth of the internal resistance increase rates of the secondary batteries which use the lithium transition metal composite oxides (#3-12, #4-14) wherein each particle has a homogeneous composition in its entirety.

From these results, it can be confirmed that in the secondary batteries which use the lithium transition metal composite oxides in accordance with the present invention, wherein the composition of the surface layer of each particle differs from the composition of the inside thereof, as the positive active materials, the internal resistance is restrained from increasing, and the storage characteristic, particularly the storage characteristic at elevated temperatures, is good even when stored in the state of high charging rates.

The lithium transition metal composite oxide in accordance with the present invention has different compositions between the surface layer of each particle thereof and the inside thereof. Accordingly, where the lithium transition metal composite oxide in accordance with the present invention is used as a positive active material of a secondary battery, the secondary battery exhibits an excellent storage characteristic that the internal resistance thereof does not increase greatly even after stored in a charged state for a long period of time. In addition, with the method for producing the lithium transition metal composite oxide in accordance with the present invention, the above-described lithium transition metal composite oxide in accordance with the present invention can be readily produced.

What is claimed is:

1. A lithium transition metal composite oxide for use as a positive active material of a lithium secondary battery, comprising:
a transition metal as a main composition element, which is composed of at least one selected from the group consisting of Co, Ni and Mn, the ratio of lithium in a composition of a surface layer of each particle of said lithium transition metal composite oxide being greater than the ratio of lithium in an average composition of said each particle.

2. A lithium transition metal composite oxide for use as a positive active material of a lithium secondary battery, as claimed in claim 1, wherein said ratio of lithium in said composition of said surface layer of each particle of said lithium transition metal composite oxide is 1.2 or more times said ratio of lithium in said average composition of said each particle.

3. A lithium transition metal composite oxide for use as a positive active material of a lithium secondary battery, comprising:
a transition metal as a main composition element, which is composed of at least one selected from the group consisting of Co, Ni and Mn, at least one substitution element selected from the group consisting of Al and Fe being substituted for one part of said transition metal, and said lithium transition metal composite oxide satisfying at least one of conditions:
(1) the ratio of lithium in a composition of a surface layer of each particle of said lithium transition metal composite oxide is greater than the ratio of lithium in an average composition of said each particle; and
(2) the ratio of said substitution element in said composition of said surface layer of said each particle of said lithium transition metal composite oxide is less than the ratio of said substitution element in said average composition of said each particle.

4. A lithium transition metal composite oxide for use as a positive active material of a lithium secondary battery, as claimed in claim 3, wherein said ratio of lithium in said composition of said surface layer of said each particle of said lithium transition metal composite oxide is 1.2 or more times the ratio of lithium in said average composition of said each particle.

5. A lithium transition metal composite oxide for use as a positive active material of a lithium secondary battery, as claimed in claim 3, wherein said ratio of said substitution element in said composition of said surface layer of said each particle of said lithium transition metal composite oxide is 0.8 or less times the ratio of said substitution element in said average composition of said each particle.

6. A method for producing a lithium transition metal composite oxide for use as a positive active material of a lithium secondary battery, which includes a transition metal as a main composition element, said transition metal being composed of at least one selected from the group consisting of Co, Ni and Mn, and the ratio of lithium in a composition of a surface layer of each particle of said lithium transition metal composite oxide being greater than the ratio of lithium in an average composition of said each particle, comprising:
a first mixing step of mixing a lithium compound as a lithium source with a compound composed of at least one selected from the group consisting of Co, Ni and Mn as a transition metal source to obtain a first mixture;
a first firing step of firing said first mixture in an oxygen atmosphere to obtain a first lithium transition metal composite oxide;
a second mixing step of mixing said first lithium transition metal composite oxide with a lithium compound as a lithium source to obtain a second mixture; and
a second firing step of firing said second mixture in an oxygen atmosphere to obtain a second lithium transition metal composite oxide.

7. A method for producing a lithium transition metal composite oxide for use as a positive active material of a lithium secondary battery, which includes a transition metal as a main composition element, said transition metal being composed of at least one selected from the group consisting of Co, Ni and Mn, and at least one substitution element selected from the group consisting of Al and Fe being substituted for one part of said transition metal, and said lithium transition metal composite oxide satisfying at least one of conditions (1) the ratio of lithium in a composition of a surface layer of each particle of said lithium transition metal composite oxide is greater than the ratio of lithium in an average composition of said each particle, and (2) the ratio of said substitution element in said composition of said surface layer of said each particle of said lithium transition metal composite oxide is less than the ratio of said substitution element in said average composition of said each particle, comprising:
a first mixing step of mixing a lithium compound as a lithium source with a compound composed of at least one selected from the group consisting of Co, Ni and Mn as a transition metal source and a compound composed of at least one selected from the group consisting of Al and Fe as a substitution element source to obtain a first mixture;
a first firing step of firing said first mixture in an oxygen atmosphere to obtain a first lithium transition metal composite oxide;
a second mixing step of mixing said first lithium transition metal composite oxide with a lithium compound as a lithium source and a compound composed of at least one selected from the group consisting of Co, Ni and Mn as a transition metal source, as required, to obtain a second mixture; and
a second firing step of firing said second mixture in an oxygen atmosphere to obtain a second lithium transition metal composite oxide.
